(19) United States
(12) Patent Application Publication
(10) Pub. No.: US 2019/0065103 A1
(43) Pub. Date: Feb. 28, 2019

(54) TRANSMISSION DEVICE AND TRANSMISSION METHOD

(71) Applicant: FUJITSU LIMITED, Kawasaki-shi (JP)

(72) Inventor: Kazuya Ryu, Fukuoka (JP)

(73) Assignee: FUJITSU LIMITED, Kawasaki-shi (JP)

(21) Appl. No.: 16/113,031

(22) Filed: Aug. 27, 2018

(30) Foreign Application Priority Data
Aug. 31, 2017 (JP) 2017-167136

(51) Int. Cl. G06F 3/06

(52) U.S. Cl. CPC G06F 3/0656; G06F 3/0673; G06F 3/0604

(57) ABSTRACT

A transmission device includes circuitry that writes, each time input data reaches a predetermined amount, the predetermined amount of the input data to a memory; and a buffer that stores data that is included in the input data and that is not written to the memory by the circuitry, wherein the circuitry is configured to: read, from the memory, first data among target data for which a read request is issued, the first data being included in the input data and being written to the memory, and read, from the buffer, second data among the target data, the second data being included in the input data and not being written to the memory.

### CROSS-REFERENCE TO RELATED APPLICATION

This application is based upon and claims the benefit of priority of the prior Japanese Patent Application No. 2017-167136, filed on Aug. 31, 2017, the entire contents of which are incorporated herein by reference.

### FIELD

The embodiment discussed herein is related to a transmission device and a transmission method.

### BACKGROUND

Heretofore, burst transfer has been known in which a plurality of data transfer processes are performed with a single address designation to thereby partly omit procedures, such as address designation. The burst transfer may also be called burst access, burst mode, continuous access, or the like. There is a technology in which input packet data is sequentially stored in a buffer, the data is written to a memory unit when a predetermined amount of data is stored, and the data is read from the memory unit in response to an output instruction (see, for example, Japanese Laid-open Patent Publication No. 2013-135383).

However, in the above-described related technology, no data is written to the memory unit until a certain amount of data is accumulated in the buffer. Thus, there is a problem that when a read request for data before the data is written to the memory unit is issued, the amount of delay in reading the data increases. In view of the foregoing, it is desirable to be able to reduce the amount of delay in reading data.

### SUMMARY

According to an aspect of the invention, a transmission device includes circuitry that writes, each time input data reaches a predetermined amount, the predetermined amount of the input data to a memory; and a buffer that stores data that is included in the input data and that is not written to the memory by the circuitry, wherein the circuitry is configured to: read, from the memory, first data among target data for which a read request is issued, the first data being included in the input data and being written to the memory, and read, from the buffer, second data among the target data, the second data being included in the input data and not being written to the memory.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a diagram illustrating an example of a memory-access control circuit according to an embodiment;

FIG. 2 is a diagram illustrating an example of a packet transmission device to which the memory-access control circuit according to the embodiment is applied;

FIG. 3 is a flowchart illustrating an example of packet input processing performed by the memory-access control circuit according to the embodiment;

FIG. 4 is a flowchart illustrating an example of packet output processing performed by the memory-access control circuit according to the embodiment;

FIG. 5 is a sequence diagram illustrating an example of a flow of access from the memory-access control circuit according to the embodiment to a large-capacity memory device;

FIG. 6 illustrates an example of packet input/output performed by the memory-access control circuit according to the embodiment; and

FIG. 7 illustrates an example of processing performed by the individual elements in the access control section according to the embodiment.

### DESCRIPTION OF EMBODIMENT

A transmission device and a transmission method according to an embodiment in the present disclosure will be described below in detail with reference to the accompanying drawings.

### (Embodiment)

(Memory-Access Control Circuit According to Embodiment)

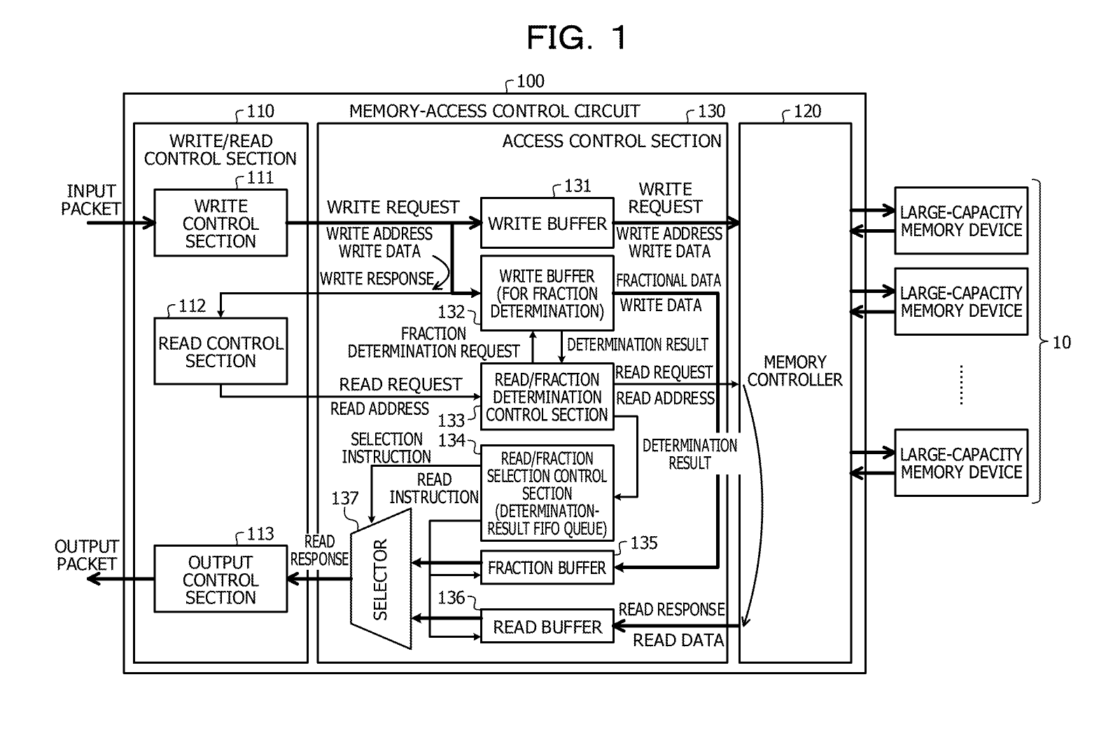

FIG. 1 is a diagram illustrating an example of a memory-access control circuit according to an embodiment. As illustrated in FIG. 1, a memory-access control circuit 100 according to the embodiment is a transmission device including a write/read control section 110, a memory controller 120, and an access control section 130. The write/read control section 110 includes a write control section 111, a read control section 112, and an output control section 113. The access control section 130 includes write buffers 131 and 132, a read/fraction determination control section 133, a read/fraction selection control section 134, a fraction buffer 135, a read buffer 136, and a selector 137.

A large-capacity memory device 10 is accessible by the memory controller 120. Each large-capacity memory device 10 is, for example, a DDR4-SDRAM. DDR4 is an acronym for double data rate 4. SDRAM is an acronym for synchronous dynamic random-access memory. The large-capacity memory device 10 may be implemented by one memory device or may be implemented by a plurality of memory devices.

Packets to be input to the memory-access control circuit 100 are input to the write control section 111. The packets to be input to the memory-access control circuit 100 are, for example, random-length packets that are input on an irregular basis. Examples of the packets include Ethernet packets. Ethernet is a registered trademark. The write control section 111 generates a write request for the input packets and outputs the generated write request to the write buffers 131 and 132.

The write request includes a write address and write data. The write address is an address indicating an area that is included in a storage area in the large-capacity memory device 10 and to which the write data is to be written. The write data is data to be written to the memory-access control circuit 100. For example, the write data includes packets input to the write control section 111. Alternatively, the write data is data included in packets input to the write control section 111.

The write buffer 131 stores therein write requests output from the write/read control section 110. When write requests corresponding to a predetermined amount TH are stored, the write buffer 131 performs burst transfer (burst access) by collectively outputting the write requests corresponding to the predetermined amount TH to the memory controller 120. The predetermined amount TH is the amount of data that is a unit of burst transfer.

Based on the write requests output from the write buffer 131, the memory controller 120 performs writing using burst transfer to the large-capacity memory device 10. For example, the memory controller 120 sequentially writes write data corresponding to the predetermined amount TH to an area in the large-capacity memory device 10, the area being indicated by a front-end write address in the write requests output from the write buffer 131 and corresponding to the predetermined amount TH. This makes it possible to perform burst transfer for which notifications of write addresses other than the front-end write address are omitted.

The write buffer 132 is a buffer for fraction determination and stores therein write requests output from the write/read control section 110, similarly to the write buffer 131. Upon storing write requests corresponding to the predetermined amount TH, the write buffer 132 outputs the write requests corresponding to the predetermined amount TH and then discards the write requests. This allows the write buffer 132 to store write requests whose contents are the same as the write requests in the write buffer 131. When a write request is output from the write/read control section 110, the write buffer 132 outputs a write response indicating that writing is completed to the write/read control section 110.

Each of the write buffers 131 and 132 is a storage medium whose capacity is smaller than that of the large-capacity memory device 10. For example, each of the write buffers 131 and 132 has a capacity corresponding to the amount of data that is a unit of burst transfer to the large-capacity memory device 10. Each of the write buffers 131 and 132 is a storage medium whose access (writing and reading) speed is higher than an access speed of the large-capacity memory device 10.

After the write response is received from the write buffer 132, the read control section 112 outputs, to the read/fraction determination control section 133, a read request for write data corresponding to the write response. The read request includes a read address indicating a read-target area in the storage area in the large-capacity memory device 10. The read request is issued from the read control section 112, for example, based on control information (an output instruction) from outside of the memory-access control circuit 100.

When the read control section 112 outputs the read request, the read/fraction determination control section 133 outputs, to the write buffer 132, a fraction determination request including a read address included in the read request. The read/fraction determination control section 133 then outputs, to the read/fraction selection control section 134, a determination result output from the write buffer 132 in response to the output fraction determination request. When the determination result output from the write buffer 132 indicates that no fractional data is stored, the read/fraction determination control section 133 outputs the read request, output from the read control section 112, to the memory controller 120.

When the read/fraction determination control section 133 outputs a fraction determination request, the write buffer 132 determines whether or not a write request (fractional data) including a write address having the same value as that of a read address included in the fraction determination request is stored in the write buffer 132. The write buffer 132 then outputs a determination result to the read/fraction determination control section 133. Upon determining that a write request including a write address having the same value as that of a read address included in the fraction determination request is stored in the write buffer 132, the write buffer 132 outputs write data included in the write request to the fraction buffer 135 as fractional data.

Based on the read request output from the read/fraction determination control section 133, the memory controller 120 performs reading from the large-capacity memory device 10. For example, the memory controller 120 reads data stored in an area in the large-capacity memory device 10, the area being indicated by a read address included in the read request. The memory controller 120 then outputs a read response including the read data to the read buffer 136. Burst transfer may also be employed when the memory controller 120 reads the data from the large-capacity memory device 10.

The read/fraction selection control section 134 has a FIFO queue (a determination-result FIFO queue) in which determination results output from the read/fraction determination control section 133 are stored. FIFO is an acronym for first-in first-out. The read/fraction selection control section 134 reads a determination result stored in the determination-result FIFO queue. Based on the read determination result, the read/fraction selection control section 134 outputs a read instruction to the fraction buffer 135 or the read buffer 136. The read/fraction selection control section 134 outputs, to the selector 137, a selection instruction for selecting a read response output from the fraction buffer 135 or the read buffer 136 to which the read instruction was output.

The fraction buffer 135 is a buffer for bypassing, as read data, the write data accumulated in the write buffer 132. For example, the fraction buffer 135 stores fractional data output from the write buffer 132. Based on the read instruction output from the read/fraction selection control section 134, the fraction buffer 135 outputs the stored fractional data to the selector 137.

The read buffer 136 stores the read response output from the memory controller 120. Based on the read instruction output from the read/fraction selection control section 134, the read buffer 136 outputs the stored read response to the selector 137.

Based on the selection instruction output from the read/fraction selection control section 134, the selector 137 selects the read response output from the fraction buffer 135 or the fractional data output from the read buffer 136 and outputs the selected read response or fractional data to the output control section 113.

The output control section 113 outputs, to outside of the memory-access control circuit 100, packets (output packets) in which the data included in the read response or fractional data output from the selector 137 is stored.

The write/read control section 110, the memory controller 120, and the access control section 130 may be implemented by, for example, one or more digital circuits, such as an ASIC or an FPGA. ASIC is an acronym for application-specific integrated circuit. FPGA is an acronym for field programmable gate array.

The above description has been given of a configuration in which the write buffer 132 is provided separately from the write buffer 131. With this configuration, the write buffers 131 and 132 can be implemented by respective independent memories without use of a memory having two or more ports for reading. Thus, it is possible to simultaneously execute write control on the large-capacity memory device 10 and a fraction determination. However, the above-described functions of the write buffer 132 may be provided in the write buffer 131 without provision of the write buffer 132. In this case, for example, the write buffer 131 may be realized by a memory having two or more ports for reading.

When packets from a plurality of flows are input to the memory-access control circuit 100, the memory-access control circuit 100 performs the above-described processing on the packets from each of the flows. In this case, for example, the write buffers 131 and 132 and the read buffer 136 may be provided for each of the flows. The fraction buffer 135 may be realized by a buffer common to the flows.

Each of the write buffers 131 and 132 and the read buffer 136 may be realized as a buffer for accumulating data in a unit of burst transfer to the large-capacity memory device 10, in order to efficiently access the large-capacity memory device 10. Each of the write buffers 131 and 132 stores therein data for which low-order addresses of write addresses included in write requests from the write control section 111 correspond to 0 to 2ⁿ-1. The read buffer 136 stores therein data for which low-order addresses of read addresses included in read requests from the read control section 112 correspond to 0 to 2ⁿ-1. Data for which the low-order addresses of the write addresses correspond to 0 to 2ⁿ-1 is data for which the low-order addresses are 0 to 3 when single access to the large-capacity memory device 10 corresponds to four addresses.

A writing section for writing, each time data input to the memory-access control circuit 100 reaches a predetermined amount, the predetermined amount of data to the large-capacity memory device 10 may be realized by, for example, the access control section 130 illustrated in FIG. 1. For example, the writing section may be realized by the write buffer 131. A buffer for storing data that the writing section has not written to the large-capacity memory device 10 may be realized by, for example, the write buffer 132 illustrated in FIG. 1. A reading section for reading data for which a read request is issued may be realized by, for example, the access control section 130 illustrated in FIG. 1. For example, the reading section may be realized by the read/fraction determination control section 133, the read/fraction selection control section 134, the fraction buffer 135, the read buffer 136, and the selector 137.

(Packet Transmission Device to Which Memory-Access Control Circuit 100 According to Embodiment is Applied)

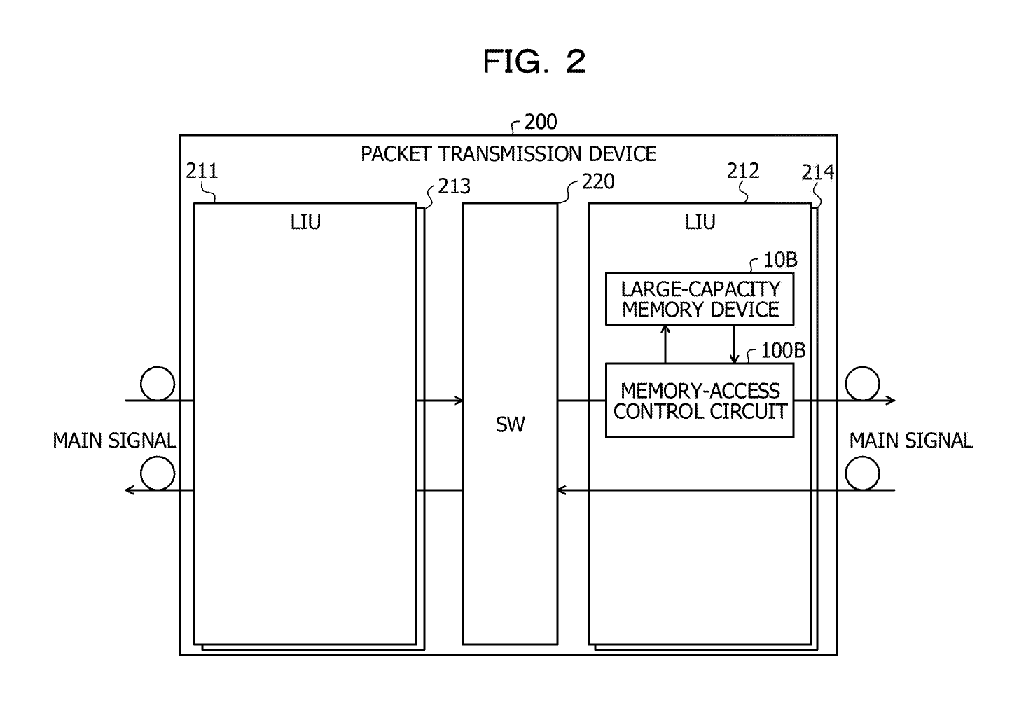

FIG. 2 is a diagram illustrating an example of a packet transmission device to which the memory-access control circuit according to the embodiment is applied. The memory-access control circuit 100 illustrated in FIG. 1 may be applied to a packet transmission device 200 illustrated in FIG. 2, by way of example. The packet transmission device 200 is an L2 switch including LIUs 211 to 214. The LIU is an acronym for line interface unit.

The LIU 211 is a transmission device that outputs a main signal, received from another transmission device, to a switch (SW) 220. The LIU 211 includes a memory-access control circuit 100A and a large-capacity memory device 10A. The memory-access control circuit 100A and the large-capacity memory device 10A are constituent elements corresponding to the memory-access control circuit 100 and the large-capacity memory device 10, respectively, illustrated in FIG. 1.

For example, the memory-access control circuit 100A stores a main signal, output from the SW 220, in the large-capacity memory device 10A. The memory-access control circuit 100A then reads the main signal, stored in the large-capacity memory device 10A, in accordance with a read instruction and transmits the read main signal to another transmission device. However, there are cases in which the main signal input to the memory-access control circuit 100A is read as fractional data without being stored in the large-capacity memory device 10A, as described above.

Although the configuration of the LIU 211 has been described above, the configurations of the LIUs 212 to 214 are the same as or similar to the configuration of the LIU 211. For example, the LIU 212 is a transmission device including a memory-access control circuit 100B and a large-capacity memory device 10B. The memory-access control circuit 100B and the large-capacity memory device 1013 are constituent elements corresponding to the memory-access control circuit 100 and the large-capacity memory device 10, respectively, illustrated in FIG. 1.

The SW 220 outputs a main signal, output from the LIU 211, to one of the LIUs 212 to 214. The SW 220 outputs a main signal, output from the LIU 212, to one of the LIUs 211, 213, and 214. The SW 220 outputs a main signal, output from the LIU 213, to one of the LIUs 211, 212, and 214. The SW 220 outputs a main signal, output from the LIU 214, to one of the LIUs 211 to 213.

The above description has been given of a configuration in which the packet transmission device 200 includes four LIUs (the LIUs 211 to 214). However, the packet transmission device 200 may have a configuration including five or more LIUs. Alternatively, the packet transmission device 200 may have a configuration including three LIUs.

For example, in order to perform real-time transmission of high-band transmission data in the packet transmission device 200 illustrated in FIG. 2, it is important to reduce the amount of delay in the packet transmission device 200. To this end, for example, applying the memory-access control circuit 100 to the LIUs 211 to 214 makes it possible to reduce the amount of transmission delay due to delay in burst transfer to the large-capacity memory device 10A.

The memory-access control circuit 100 may be applied not only to the LIUs 211 to 214 that directly transmit an input main signal but also to various types of transmission device. For example, the LIU 211 may be a transmission device that splits large-size data (for example, 10 Gb/s data) output from the SW 220 into a plurality of pieces of small-size data (for example, five streams of 1 Gb/s data) via round robin or the like and transmits the plurality of pieces of small-size data.

In this case, the memory-access control circuit 100A and the large-capacity memory device 10A may be provided at a stage prior to a splitter that is included in the LIU 211 and that splits large-size data into a plurality of pieces of small-size data. With this configuration, large-size data is temporarily stored in the large-capacity memory device 10A, and through issuance of a read instruction to the memory-access control circuit 100A, the splitter can sequentially read the large-size and split the large-size data into a plurality of pieces of small-size data.

The memory-access control circuit 100 may be applied not only to the packet transmission device 200 but also to various types of device. For example, the memory-access control circuit 100 may be applied to various types of device that transmit data in a high band and with low delay by using a large-capacity memory. Examples of the various types of device include a device that performs real time transmission of video data.

(Packet Input Processing Performed by Memory-Access Control Circuit According to Embodiment)

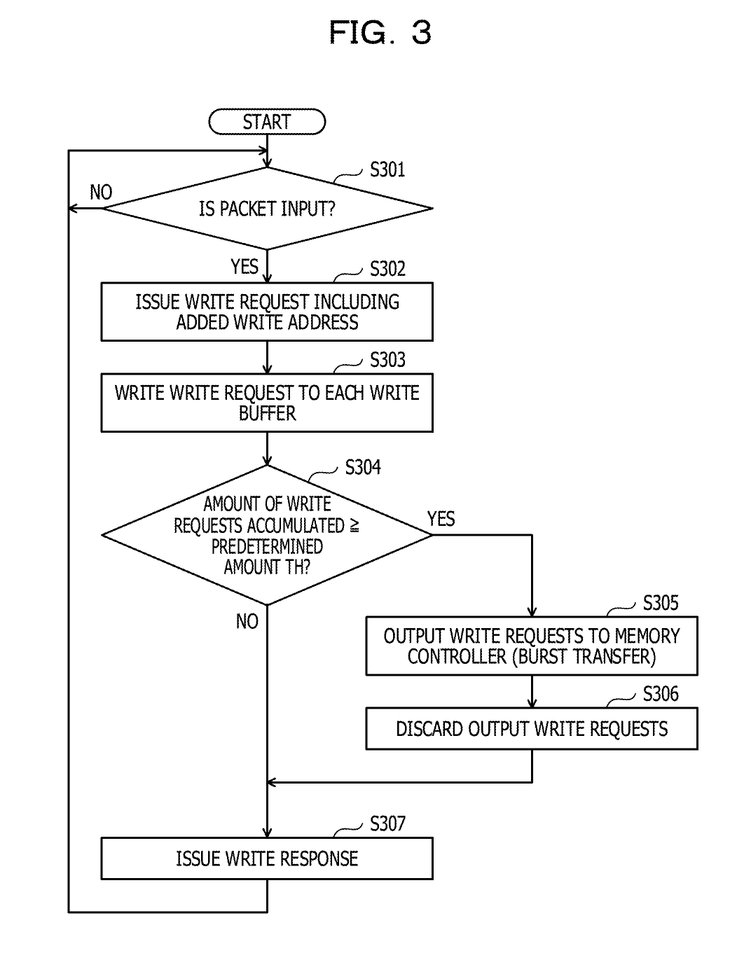

FIG. 3 is a flowchart illustrating an example of packet input processing performed by the memory-access control circuit according to the embodiment. The memory-access control circuit 100 according to the embodiment executes, for example, the steps illustrated in FIG. 3 as the packet input processing. First, the memory-access control circuit 100 determines whether or not a packet is input to the local device (S301) and waits until a packet is input (loop “No” from S301). S301 is executed by, for example, the write control section 111 illustrated in FIG. 1.

If it is determined in S301 that a packet is input (Yes in S301), the memory-access control circuit 100 adds a write address to data in the input packet. The memory-access control circuit 100 then issues a write request including the data (write data) in the packet and the added write address (S302). S302 is executed by, for example, the write control section 111 illustrated in FIG. 1.

Next, the memory-access control circuit 100 writes the write request issued in S302 to each of the write buffers 131 and 132 (S303). S303 is executed by, for example, the write control section 111 illustrated in FIG. 1.

Next, the memory-access control circuit 100 determines whether or not the amount of write requests accumulated in the write buffer 131 (or the write buffer 132) as a result of S303 reaches a predetermined amount TH (S304). The predetermined amount TH is an amount of data that is a unit of burst transfer to the large-capacity memory device 10. S304 is executed by, for example, each of the write buffers 131 and 132 illustrated in FIG. 1.

If it is determined in S304 that the amount of accumulated write requests does not reach the predetermined amount TH (No in S304), the memory-access control circuit 100 advances to S307. If the amount of accumulated write requests reaches the predetermined amount TH (Yes in S304), the memory-access control circuit 100 outputs the write requests corresponding to the predetermined amount TH, the write requests being accumulated in the write buffer 131, to the memory controller 120 (S305). As a result, the write data included in the write requests corresponding to the predetermined amount TH, the write requests being accumulated in the write buffer 131, is burst-transferred to the large-capacity memory device 10. S305 is executed by, for example, the write buffer 131 illustrated in FIG. 1.

Next, the memory-access control circuit 100 discards the write requests output in S305 (S306). S306 is executed by, for example, each of the write buffers 131 and 132 illustrated in FIG. 1.

Next, the memory-access control circuit 100 issues a write response indicating that writing for the write requests written in S303 is completed (S307), and then the process returns to S301. S307 is executed by, for example, at least one of the write buffers 131 and 132 illustrated in FIG. 1.

(Packet Output Processing Performed by Memory-Access Control Circuit According to Embodiment)

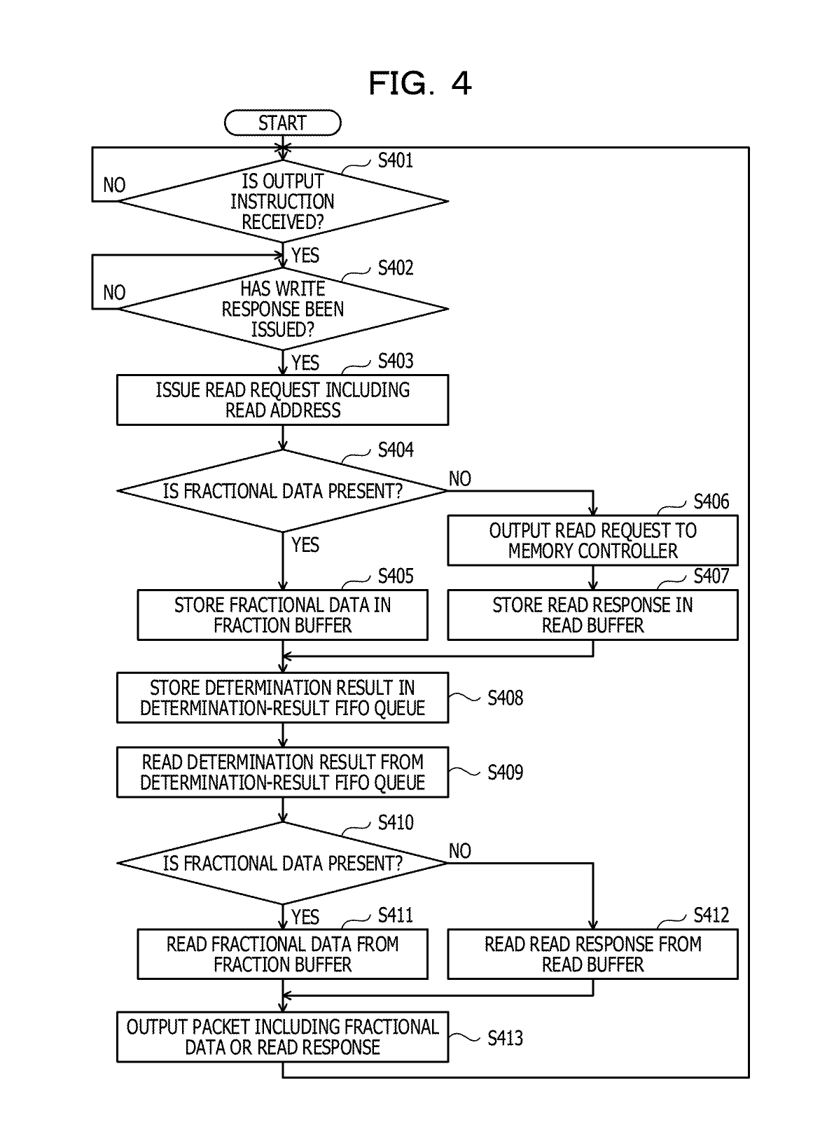

FIG. 4 is a flowchart illustrating an example of packet output processing performed by the memory-access control circuit according to the embodiment. The memory-access control circuit 100 according to the embodiment executes, for example, the steps illustrated in FIG. 4 as the packet output processing. First, the memory-access control circuit 100 determines whether or not an output instruction for packets is received (S401) and waits until the output instruction is received (loop “No” from S401). S401 is executed by, for example, the read control section 112 illustrated in FIG. 1.

If it is determined in S401 that the output instruction is received (Yes in S401), the memory-access control circuit 100 advances to S402. That is, the memory-access control circuit 100 determines whether or not a write response for data for which the output instruction is received has been issued in S307 illustrated in FIG. 3 (S402) and waits until the write response is issued (loop “No from S402). S402 is executed by, for example, the read control section 112 illustrated in FIG. 1.

If it is determined in S402 that the write response has been issued (Yes in S402), the memory-access control circuit 100 issues a read request corresponding to the write response and including a read address (S403). S403 is executed by, for example, the read control section 112 illustrated in FIG. 1.

Next, the memory-access control circuit 100 determines whether or not a write request including a write address having the same value as that of the read address in the read request issued in S403, that is, fractional data, is present in the write buffer 132 (S404). For example, S404 is executed when the read/fraction determination control section 133 illustrated in FIG. 1 issues a fraction determination request to the write buffer 132.

If it is determined in S404 that fractional data is present in the write buffer 132 (Yes in S404), the memory-access control circuit 100 reads the fractional data and stores the fractional data in the fraction buffer 135 (S405), and the process proceeds to S408. S405 is executed by, for example, the write buffer 132 illustrated in FIG. 1.

If it is determined in S404 that fractional data is not present in the write buffer 132 (No in S404), it may be determined that data corresponding to the read request has already been read from the write buffer 131 and has been written to the large-capacity memory device 10. In this case, the memory-access control circuit 100 outputs the read request, issued in S403, to the memory controller 120 (S406). As a result, burst transfer from the large-capacity memory device 10 is performed. S406 is executed by, for example, the read/fraction determination control section 133 illustrated in FIG. 1.

Next, the memory-access control circuit 100 stores, in the read buffer 136, a read response including the data read from the large-capacity memory device 10 in response to the read request output in S406 (S407). S407 is executed by, for example, the memory controller 120 illustrated in FIG. 1.

Next, the memory-access control circuit 100 stores, in the determination-result FIFO queue, the result of the determination in S404 as to whether or not the fractional data is present (S408). S408 is executed by, for example, the read/fraction selection control section 134 illustrated in FIG. 1.

Next, the memory-access control circuit 100 reads, from the determination-result FIFO queue, the result of the determination in S404 as to whether or not the fractional data is present (S409). S409 is executed by, for example, the read/fraction selection control section 134 illustrated in FIG. 1.

Next, the memory-access control circuit 100 determines whether or not the determination result read in S409 indicates that the fractional data is present (S410). If the determination result indicates that the fractional data is present (Yes in S410), the memory-access control circuit 100 reads the fractional data from the fraction buffer 135 (S411). S411 is executed, for example, when the read/fraction selection control section 134 illustrated in FIG. 1 outputs a control signal to the fraction buffer 135 and the selector 137.

If the determination result in S410 indicates that the fractional data is not present (No in S410), the memory-access control circuit 100 reads the read response from the read buffer 136 (S412). S412 is executed, for example, when the read/fraction selection control section 134 illustrated in FIG. 1 outputs a control signal to the read buffer 136 and the selector 137.

Next, the memory-access control circuit 100 outputs a packet including the fractional data read in S411 or the read response read in S412 (S413), and the process proceeds to S401. S413 is executed by, for example, the output control section 113 illustrated in FIG. 1.

(Flow of Access from Memory-Access Control Circuit According to Embodiment to Large-Capacity Memory Device)

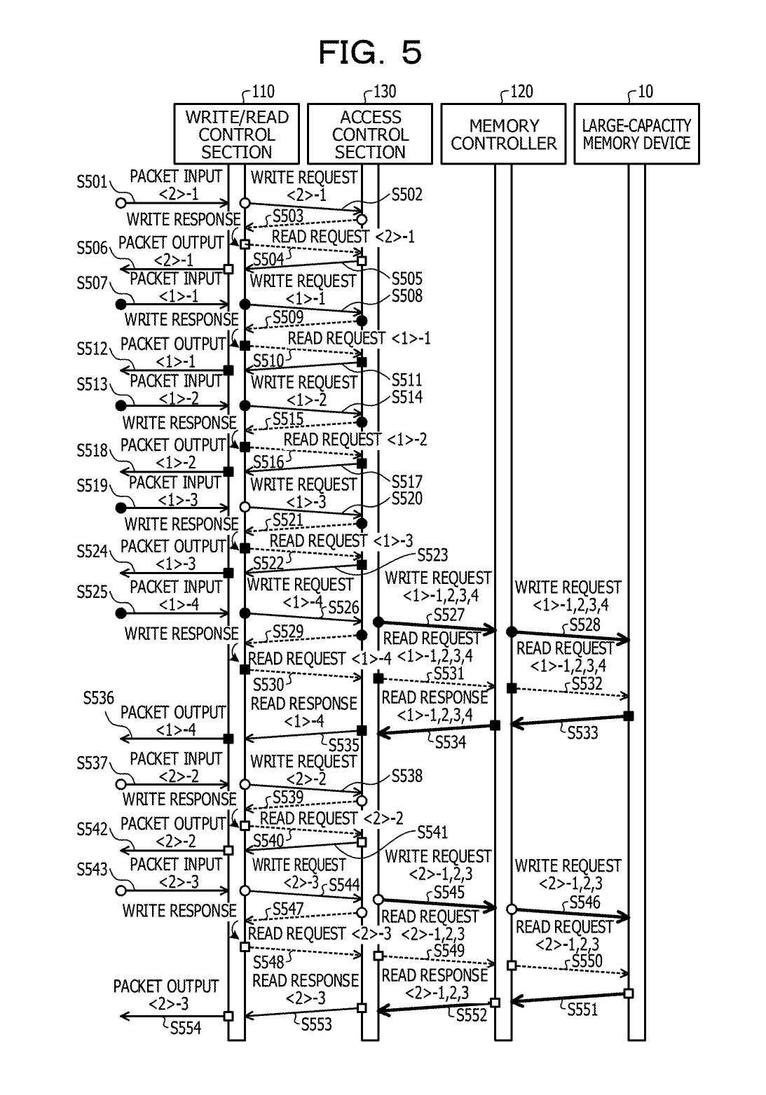

FIG. 5 is a sequence diagram illustrating an example of a flow of access from the memory-access control circuit according to the embodiment to the large-capacity memory device. The memory-access control circuit 100 executes, for example, the steps illustrated in FIG. 5. In the example illustrated in FIG. 5, packets in a first flow (<1>) and packets in a second flow (<2>) are input to the memory-access control circuit 100.

In the example illustrated in FIG. 5, the amount of data (the predetermined amount TH described above) that is a unit of burst transfer to the large-capacity memory device 10 is a data size for four packets in the first flow and is a data size for three packets in the second flow.

First, a first packet in the second flow is input from outside of the memory-access control circuit 100 (packet input <2>-1) (S501). Next, the write/read control section 110 outputs a write request (<2>-1) for the first packet in the second flow to the access control section 130 (S502). As a result, the first packet in the second flow is written to the write buffers 131 and 132 in the access control section 130. Next, the access control section 130 outputs a write response for the first packet in the second flow to the write/read control section 110 (S503).

Next, the write/read control section 110 outputs a read request (<2>-1) for the first packet in the second flow to the access control section 130 (S504). Next, the access control section 130 outputs the write request (<2>-1), written to the write buffer 132, to the write/read control section 110 as fractional data (S505). Next, the write/read control section 110 outputs a packet including the fractional data output in S505 (packet output <2>-1) (S506). As described above, in the example illustrated in FIG. 5, although the read request for the first packet in the second flow is output before the burst transfer to the large-capacity memory device 10, the first packet in the second flow can be output without waiting for the burst transfer to the large-capacity memory device 10.

After S506, a first packet in the first flow is input from outside of the memory-access control circuit 100 (packet input <1>-1) (S507). Next, the write/read control section 110 outputs a write request (<1>-1) for the first packet in the first flow to the access control section 130 (S508). As a result, the first packet in the first flow is written to the write buffers 131 and 132 in the access control section 130. Next, the access control section 130 outputs a write response for the first packet in the first flow to the write/read control section 110 (S509).

Next, the write/read control section 110 outputs a read request (<1>-1) for the first packet in the first flow to the access control section 130 (S510). Next, the access control section 130 outputs the write request (<1>-1), written to the write buffer 132, to the write/read control section 110 as fractional data (S511). Next, the write/read control section 110 outputs a packet including the fractional data output in S511 (packet output <1>-1) (S512). As described above, in the example illustrated in FIG. 5, although the read request for the first packet in the first flow is output before the burst transfer to the large-capacity memory device 10, the first packet in the first flow can be output without waiting for the burst transfer to the large-capacity memory device 10.

After S512, a second packet in the first flow is input from outside of the memory-access control circuit 100 (packet input <1>-2) (S513). Next, the write/read control section 110 outputs a write request (<1>-2) for the second packet in the first flow to the access control section 130 (S514). As a result, the second packet in the first flow is written to the write buffers 131 and 132 in the access control section 130. Next, the access control section 130 outputs a write response for the second packet in the first flow to the write/read control section 110 (S515).

Next, the write/read control section 110 outputs a read request (<1>-2) for the second packet in the first flow to the access control section 130 (S516). Next, the access control section 130 outputs the write request (<1>-2), written to the write buffer 132, to the write/read control section 110 as fractional data (S517). Next, the write/read control section 110 outputs a packet including the fractional data output in S517 (packet output <1>-2) (S518). As described above, in the example illustrated in FIG. 5, although the read request for the second packet in the first flow is output before the burst transfer to the large-capacity memory device 10, the second packet in the first flow can be output without waiting for the burst transfer to the large-capacity memory device 10.

Next, a third packet in the first flow is input from outside of the memory-access control circuit 100 (packet input <1>-3) (S519). Next, the write/read control section 110 outputs a write request (<1>-3) for the third packet in the first flow to the access control section 130 (S520). As a result, the third packet in the first flow is written to the write buffers 131 and 132 in the access control section 130. Next, the access control section 130 outputs a write response for the third packet in the first flow to the write/read control section 110 (S521).

Next, the write/read control section 110 outputs a read request (<1>-3) for third packet in the first flow to the access control section 130 (S522). Next, the access control section 130 outputs the write request (<1>-3), written to the write buffer 132, to the write/read control section 110 as fractional data (S523). Next, the write/read control section 110 outputs a packet including the fractional data output in S523 (packet output <1>-3) (S524). As described above, in the example illustrated in FIG. 5, although the read request for the third packet in the first flow is output before the burst transfer to the large-capacity memory device 10, the third packet in the first flow can be output without waiting for the burst transfer to the large-capacity memory device 10.

After S524, a fourth packet in the first flow is input from outside of the memory-access control circuit 100 (packet input <1>-4) (S525). Next, the write/read control section 110 outputs a write request (<1>-4) for the fourth packet in the first flow to the access control section 130 (S526).

As a result, the fourth packet in the first flow is written to the write buffers 131 and 132 in the access control section 130, and the total amount of the write requests for the first flow which are written to the write buffer 131 reaches the amount of data for four packets. Thus, the access control section 130 outputs the write requests (<1>-1, 2, 3, 4) for collectively requesting writing of the first to fourth packets in the first flow, the write requests being written to the write buffer 131, to the memory controller 120 (S527).

Next, the memory controller 120 outputs the write requests (<1>-1, 2, 3, 4) to the large-capacity memory device 10 (S528). As a result, the first to fourth packets in the first flow are written to the large-capacity memory device 10 via burst transfer. The access control section 130 outputs a write response for the fourth packet in the first flow to the write/read control section 110 (S529).

Next, the write/read control section 110 outputs a read request (<1>-4) for the fourth packet in the first flow to the access control section 130 (S530). Next, the access control section 130 outputs the read requests (<1>-1, 2, 3, 4) for the first to fourth packets in the first flow, the first to fourth packets being written to the large-capacity memory device 10 via burst transfer, to the memory controller 120 (S531).

Next, the memory controller 120 outputs the read requests (<1>-1, 2, 3, 4) to the large-capacity memory device 10 (S532). Next, the large-capacity memory device 10 reads the first to fourth packets in the first flow and outputs the read first to fourth packets in the first flow to the memory controller 120 as read responses (<1>-1, 2, 3, 4) (S533). Next, the memory controller 120 outputs the read responses (<1>-1, 2, 3, 4) to the access control section 130 (S534).

Next, the access control section 130 outputs, to the write/read control section 110, the read response (<1>-4) that is included in the read responses (<1>-1, 2, 3, 4) and that includes fourth data in the first flow (S535). Next, the write/read control section 110 outputs a packet including the data included in the read response (<1>-4) (packet output <1>-4) (S536).

Next, a second packet in the second flow is input from outside of the memory-access control circuit 100 (packet input <2>-2) (S537). Next, the write/read control section 110 outputs a write request (<2>-2) for the second packet in the second flow to the access control section 130 (S538). As a result, the second packet in the second flow is written to the write buffers 131 and 132 in the access control section 130. Next, the access control section 130 outputs a write response for the second packet in the second flow to the write/read control section 110 (S539).

Next, the write/read control section 110 outputs a read request (<2>-2) for the second packet in the second flow to the access control section 130 (S540). Next, the access control section 130 outputs the write request (<2>-2), written to the write buffer 132, to the write/read control section 110 as fractional data (S541). Next, the write/read control section 110 outputs a packet including the fractional data output in S541 (packet output <2>-2) (S542). As described above, in the example illustrated in FIG. 5, although the read request for the second packet in the second flow is output before the burst transfer to the large-capacity memory device 10, the second packet in the second flow can be output without waiting for the burst transfer to the large-capacity memory device 10.

Next, a third packet in the second flow is input from outside of the memory-access control circuit 100 (packet input <2>-3) (S543). Next, the write/read control section 110 outputs a write request (<2>-3) for the third packet in the second flow to the access control section 130 (S544).

As a result, the third packet in the second flow is written to the write buffers 131 and 132 in the access control section 130, and the total amount of the write requests for the second flow which were written to the write buffer 131 reaches the amount of data for three packets. Thus, the access control section 130 outputs the write requests (<2>-1,2,3) for collectively requesting writing of the first to third packets in the second flow, the write requests being written to the write buffer 131, to the memory controller 120 (S545).

Next, the memory controller 120 outputs the write requests (<2>-1,2,3) to the large-capacity memory device 10 (S546). As a result, the first to third packets in the second flow are written to the large-capacity memory device 10 via burst transfer. The access control section 130 outputs a write response for the third packet in the second flow to the write/read control section 110 (S547).

Next, the write/read control section 110 outputs a read request (<2>-3) for the third packet in the second flow to the access control section 130 (S548). Next, the access control section 130 outputs, to the memory controller 120, the read requests (<2>-1,2,3) for the first to third packets in the second flow which were written to the large-capacity memory device 10 via burst transfer (S549).

Next, the memory controller 120 outputs the read requests (<2>-1,2,3) to the large-capacity memory device 10 (S550). Next, the large-capacity memory device 10 reads the first to third packet in the second flow and outputs the read first to third packet in the second flow to the memory controller 120 as read responses (<2>-1,2,3) (S551). Next, the memory controller 120 outputs the read responses (<2>-1,2,3) to the access control section 130 (S552).

Next, the access control section 130 outputs, to the write/read control section 110, the read response (<2>-3) that is included in the read responses (<2>-1,2,3) and that includes third data in the second flow (S553). Next, the write/read control section 110 outputs a packet including the data included in the read response (<2>-3) (packet output <2>-3) (S554).

(Packet Input/Output Performed by Memory-Access Control Circuit According to Embodiment)

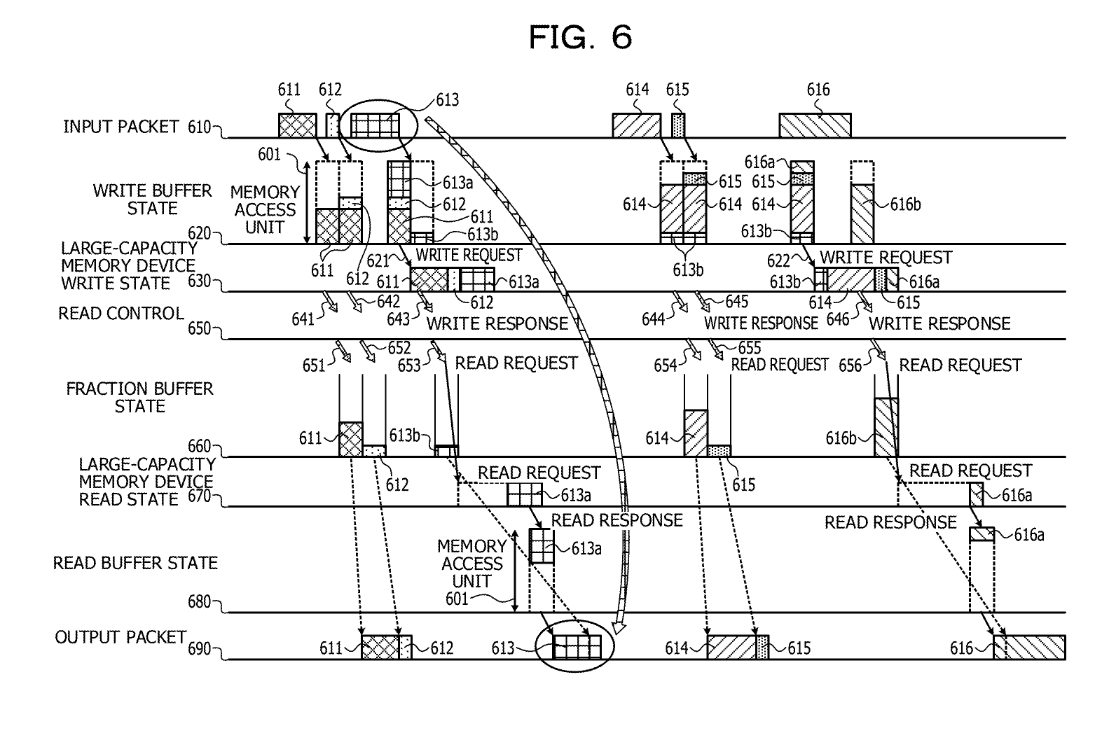

FIG. 6 illustrates an example of packet input/output performed by the memory-access control circuit according to the embodiment. In FIG. 6, the horizontal axis represents time. A memory access unit 601 illustrated in FIG. 6 indicates the amount of data (a predetermined amount TH) that is a unit of burst transfer to the large-capacity memory device 10. An input packet 610 illustrated in FIG. 6 represents packets input to the memory-access control circuit 100. A write buffer state 620 represents a state of packets stored in the write buffers 131 and 132. A large-capacity memory device write state 630 represents a state of packets written to the large-capacity memory device 10.

As illustrated in the input packet 610, a packet 611 is first input to the memory-access control circuit 100, a packet 612 is input, and then a packet 613 is input. A packet 614 is input next to the packet 613, a packet 615 is input, and then a packet 616 is input. Each of the packets 611 to 616 includes one or more packets (data).

As indicated by the write buffer state 620, at the stage when the packet 611 is stored in the write buffers 131 and 132, the total amount of data in the packets stored in the write buffers 131 and 132 does not reach the memory access unit 601. Thus, although burst transfer from the write buffer 131 to the large-capacity memory device 10 is not performed, a write response 641 for the packet 611 is issued.

At the stage when the packet 612 is stored in the write buffers 131 and 132, the total amount of data in the packets stored in the write buffers 131 and 132 does not reach the memory access unit 601. Thus, although burst transfer from the write buffer 131 to the large-capacity memory device 10 is not performed, a write response 642 for the packet 612 is issued.

At the stage when the packet 613 is stored in the write buffers 131 and 132, the total amount of data in the packets stored in the write buffers 131 and 132 exceeds the memory access unit 601. Thus, a write request for, of the packets stored in the write buffer 131, the packets corresponding to the first memory access unit 601 is issued. In the example illustrated in FIG. 6, a write request 621 for the packets 611 and 612 and a packet 613a, which is a front-end portion of the packet 613 is issued. Then, a packet 613b, which is a remaining portion of the packet 613, remains in the write buffer 131. The write buffer state 620 of the write buffer 132 is also controlled so as to be the same as the write buffer state 620 of the write buffer 131.

As a result of issuance of the write request 621, the packets 611, 612, and 613a are written to the large-capacity memory device 10, as indicated by the large-capacity memory device write state 630. A write response 643 for the packet 613 is issued.

At the stage when the packet 614 and 615 are stored in the write buffers 131 and 132, the total amount of data in the packets stored in the write buffers 131 and 132 does not reach the memory access unit 601. Thus, although burst transfer from the write buffer 131 to the large-capacity memory device 10 is not performed, write responses 644 and 645 for the respective packets 614 and 615 are issued.

Then, at the stage when the packet 616 is stored in the write buffers 131 and 132, the total amount of data in the packets stored in the write buffers 131 and 132 exceeds the memory access unit 601. Thus, a write request for, of the packets stored in the write buffer 131, the packets corresponding to the first memory access unit 601 is issued. In the example illustrated in FIG. 6, a write request 622 for the packets 613b, 614, and 615 and a packet 616a, which is a front-end portion of the packet 616, is issued. Then, a packet 616b, which is a remaining portion of the packet 616, remains in the write buffer 131. The write buffer state 620 of the write buffer 132 is also controlled so as to be the same as the write buffer state 620 of the write buffer 131.

As a result of issuance of the write request 622, the packets 613b, 614, 615, and 616a are written to the large-capacity memory device 10, as illustrated in the large-capacity memory device write state 630. A write response 646 for the packet 616 is issued.

Read control 650 illustrated in FIG. 6 represents read control performed by the read control section 112 in the write/read control section 110 illustrated in FIG. 6. A fraction buffer state 660 represents a state of fractional data stored in the fraction buffer 135. A large-capacity memory device read state 670 represents a state of packets read from the large-capacity memory device 10. A read buffer state 680 represents a state of packets stored in the read buffer 136. An output packet 690 represents packets output from the output control section 113.

In the example illustrated in FIG. 6, the read control section 112 issues read requests 651 to 656 immediately after the corresponding write responses 641 to 646, as indicated by the read control 650. The read requests 651 to 656 are read requests for the packet 611 to 616, respectively.

As a result of issuance of the read request 651, the packet 611 written to the write buffer 132 is read and is written to the fraction buffer 135. The packet 611 written to the fraction buffer 135 is output from the output control section 113. As a result of issuance of the read request 652, the packet 612 written to the write buffer 132 is read and is written to the fraction buffer 135. The packet 612 written to the fraction buffer 135 is then output from the output control section 113.

As a result of issuance of the read request 653, the packet 613a stored in the large-capacity memory device 10 is read and is written to the read buffer 136. As a result of issuance of the read request 653, the packet 613b written to the write buffer 132 is read and is written to the fraction buffer 135. Then, the packet 613a written to the read buffer 136 and the packet 613b written to the fraction buffer 135 are output from the output control section 113 as the packet 613.

As a result of issuance of the read request 654, the packet 614 written to the write buffer 132 is read and is written to the fraction buffer 135. The packet 614 written to the fraction buffer 135 is then output from the output control section 113. As a result of issuance of the read request 655, the packet 615 written to the write buffer 132 is read and is written to the fraction buffer 135. The packet 615 written to the fraction buffer 135 is then output from the output control section 113.

As a result of issuance of the read request 656, the packet 616a stored in the large-capacity memory device 10 is read and is written to the read buffer 136. As a result of issuance of the read request 656, the packet 616b written to the write buffer 132 is read and is written the fraction buffer 135. Then, the packet 616a written to the read buffer 136 and the packet 616b written to the fraction buffer 135 are output from the output control section 113 as the packet 616.

(Processing Performed by Individual Elements in Access Control section According to Embodiment)

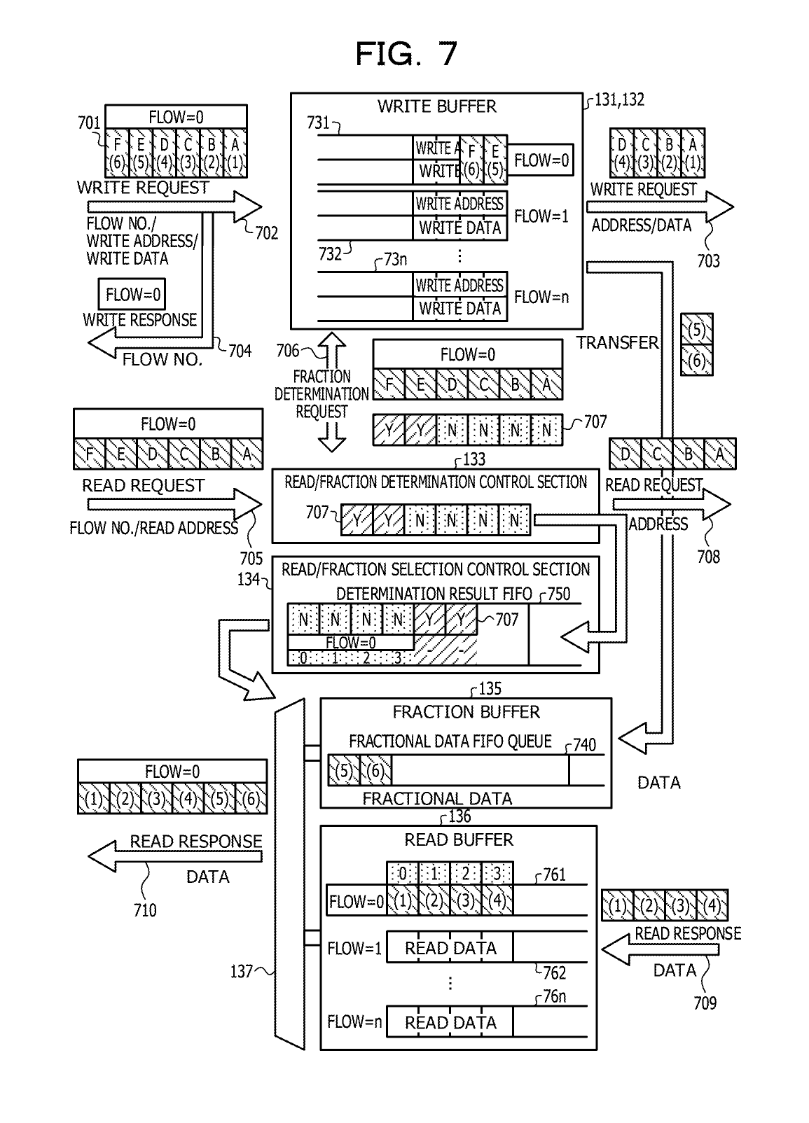

FIG. 7 illustrates an example of processing performed by the individual elements in the access control section according to the embodiment. In FIG. 7, portions that are the same as or similar to those illustrated in FIG. 1 are denoted by the same reference numerals, and descriptions thereof are not given hereinafter. In the example illustrated in FIG. 7, a write request 702 for a packet 701 in a first flow (FLOW=0) is input from the write control section 111 to the access control section 130. The write request 702 includes a first flow identifier (a FLOW number), write addresses, and write data. The packet 701 includes data (1) to (6) for six addresses as the write data. The write addresses of data (1) to (6) are denoted by A to F, respectively.

Each of the write buffers 131 and 132 has write FIFO queues 731 to 73n corresponding to respective different flows (FLOW=0 to n). The data (1) to (6) are written to the write FIFO queue 731 in each of the write buffers 131 and 132.

It is now assumed that the total amount of the data (1) to (4) reaches the amount of data (the predetermined amount TH) that is a unit of burst transfer to the large-capacity memory device 10. In this case, a write request 703 for the data (1) to (4) is output to the memory controller 120. As a result, the memory controller 120 specifies, for the large-capacity memory device 10, the write address (A) of the data (1) and burst-transfers the data (1) to (4). As illustrated in FIG. 7, write requests for data (5) and (6) are held in the write buffers 131 and 132.

When write requests for the data (1) to (6) are input to the write buffers 131 and 132, a write response 704 indicating that writing of the first flow is completed is issued to the read control section 112. The write response 704 includes, for example, the FLOW number (FLOW=0), which is an identifier of the first flow.

Next, the read control section 112 issues a read request 705 for the data (1) to (6) to the access control section 130. The read request 705 includes, for example, the FLOW number (FLOW=0), which is the identifier of the first flow, and read addresses (A to F) of the data (1) to (6).

Next, the read/fraction determination control section 133 issues, to the write buffer 132, a fraction determination request 706 for determining whether or not write requests for the read addresses (A to F) included in the read request 705 are held in the write buffer 132. The fraction determination request 706 includes, for example, the FLOW number (FLOW=0), which is the identifier of the first flow, and the read addresses (A to F) of the data (1) to (6) in the first flow.

In the example illustrated in FIG. 7, in response to the fraction determination request 706, a determination result 707 indicating that write requests for the addresses E and F are held in the write buffer 132 is output from the write buffer 132 to the read/fraction determination control section 133. The determination result 707 includes information indicating whether or not a write request for each of the addresses (A to F) included in the fraction determination request 706 is held in the write buffer 132 (in the determination result 707 in FIG. 7, “Y” indicates that a write request for the corresponding address is held, and “N” indicates that a write request for the corresponding address is not held).

Data corresponding to write requests determined to be held in response to the fraction determination request 706 are transferred from the write buffer 132 to the fraction buffer 135. In the example illustrated in FIG. 7, the data (5) and (6) are transferred from the write buffer 132 to the fraction buffer 135. The fraction buffer 135 has a fractional data FIFO queue 740. The data (5) and (6) are written to the fractional data FIFO queue 740 in the fraction buffer 135.

A read request 708 for requesting reading of data corresponding to write requests determined not to be held in response to the fraction determination request 706 is issued to the large-capacity memory device 10 via the memory controller 120. In the example illustrated in FIG. 7, the read request 708 includes the read addresses (A to D) of the data (1) to (4).

The read/fraction determination control section 133 outputs the determination result 707, output from the write buffer 132, to the read/fraction selection control section 134. The read/fraction selection control section 134 has a determination-result FIFO queue 750. The read/fraction selection control section 134 stores, in the determination-result FIFO queue 750, the determination result 707 output from the read/fraction determination control section 133, the FLOW number (FLOW=0), which is the identifier of the first flow, and an address in the read buffer 136.

For example, the determination result 707 includes determination results for the six addresses and indicates that no write request is held in the write buffer 132 for the first four addresses (A to D) and write requests are held in the write buffer 132 for the last two addresses (E and F). Thus, the read/fraction selection control section 134 stores, in the determination-result FIFO queue 750, four addresses (0 to 3 in the example illustrated in FIG. 7) in the read buffer 136. Then, the read/fraction selection control section 134 sequentially stores two empty addresses (“-”) in the determination-result FIFO queue 750.

In response to the read request 708 issued to the large-capacity memory device 10, the large-capacity memory device 10 outputs a read response 709 to the read buffer 136 via the memory controller 120. In the example illustrated in FIG. 7, the read response 709 includes the data (1) to (4). The read buffer 136 has read FIFO queues 761 to 76n corresponding to the respective different flows (FLOW=0 to n). The data (1) to (4) are written to the read FIFO queue 761 in the read buffer 136 which corresponds to the first flow.

The read buffer 136 may store therein the read addresses (A to D) of the data (1) to (4) (read data), together with the data (1) to (4). This makes it possible to determine which read address each piece of read data in the read buffer 136 corresponds. This makes it possible to determine whether or not the read data from the large-capacity memory device 10 is stored in the read buffer 136.

In accordance with an order of information accumulated in the determination-result FIFO queue 750 (that is, an order of read requests), the read/fraction selection control section 134 outputs a read instruction to the fraction buffer 135 or the read buffer 136 and a selection instruction to the selector 137. In the example illustrated in FIG. 7, information corresponding to six addresses is accumulated in the determination-result FIFO queue 750. The read/fraction selection control section 134 then performs control for reading data for the first four addresses from the read buffer 136 and reading data for the subsequent two addresses from the fraction buffer 135. The data for the first four addresses is data read from the large-capacity memory device 10. Thus, the read/fraction selection control section 134 waits for read responses for data for the first four addresses to be accumulated in the read buffer 136 and then the read/fraction selection control section 134 performs control for reading the data.

In accordance with control performed by the read/fraction selection control section 134, the selector 137 outputs the data, read from the fraction buffer 135 or the read buffer 136, to the output control section 113 as a read response 710. In the example illustrated in FIG. 7, the selector 137 selects the first four pieces of data (1) to (4) from the read buffer 136, then selects the data (5) and (6) from the fraction buffer 135, and outputs the selected data (1) to (6) to the output control section 113 as the read response 710.

For example, when fractional data is stored, the selector 137 selects the data stored in the fraction buffer 135. When no fractional data is stored, and the read-target address in the read buffer 136 is a front end (for example, 0), the selector 137 waits for a read response to be received from the large-capacity memory device 10 and then selects the data in the read FIFO queue 761 corresponding to the first flow. When no fractional data is stored, and the read-target address in the read buffer 136 is not a front-end, the selector 137 selects the data in the read FIFO queue 761 corresponding to the first flow.

The description in the example illustrated in FIG. 7 has been given of a configuration in which the amount of data (the predetermined amount TH) that is a unit of burst transfer to the large-capacity memory device 10 is the amount of data for four addresses. However, the amount of data that is a unit of burst transfer to the large-capacity memory device 10 is not limited to that amount of data. For example, the amount of data that is a unit of burst transfer to the large-capacity memory device 10 may be the amount of data for 2ⁿ addresses, such as 2, 4, 8, 16, . . . addresses. A larger unit of the burst transfer to the large-capacity memory device 10 allows higher-band access to the large-capacity memory device 10.

As described above, in the memory-access control circuit 100 according to the embodiment, data that is included in input data and that has not been written to a memory (the large-capacity memory device 10) can be stored in a buffer (the write buffer 132). Of data for which a read request is issued, data that has been written to the memory can be read, and of the data for which the read data is issued, data that has not been written to the memory can be read from the buffer. Thus, in a configuration in which each time the amount of input data reaches a predetermined amount, burst transfer for writing the predetermined amount of data to the memory is performed, data for which a read request is issued before being stored in the memory can be read from the buffer without waiting for the data to be stored in the memory. Thus, it is possible to reduce the amount of delay in reading data.

When a read request is issued, a determination as to whether or not the data for which the read request is issued has been written to the memory can be made based on a result of comparison between a read address of data for which the read request is issued and a write address of data written to the buffer. Thus, a determination as to whether or not the data for which the read request is issued has been written to the memory can be made without accessing the memory controller 120. Accordingly, it is possible to suppress an increase in access of the memory controller 120, the increase being caused by a determination as to whether or not data for which a read request is issued has been written to the memory.

The buffer in which data that is included in input data and that has not been written to the memory is stored and in which data for which a read request is issued before being written to the memory may be implemented by a buffer that is different from a buffer in which data to be written to the memory is stored. This makes it possible to simultaneously execute write control on the memory and a determination as to whether or not data for which a read request is issued has been written to the memory.

As described above, according to the transmission device and the transmission method, it is possible to reduce the amount of delay in reading data

For example, in conjunction with increases in the speed of information transmission and amounts of transmission information, there are demands for high-band large-capacity memories. An increase in the interface speed and burst transfer (continuous access) enables high-band memory access to large-capacity memories, such as DDR4-SDRAMs. However, for single access (one-shot access), even when the interface speed is increased, the access band does not change due to structural operational constraints of the SDRAMs.

Thus, high-band memory access is realized by using a write buffer and a read buffer to temporarily store data to be written to and data read from a large-capacity memory and by performing access control so that continuous access is made to the large-capacity memory.

In a device in which random-length packets, such as Ethernet packets, that are input on an irregular basis are buffered, accumulation in the write buffer is completed on an irregular basis, which may result in a large amount of delay in a write request to the large-capacity memory. Accordingly, there is a problem that it is difficult to perform read control with low delay.

In contrast, according to the embodiment, even for random-length packets that are input on an irregular basis, access to the large-capacity memory can be made in a high band and with low delay. For example, fractional data accumulated in the write buffer before being written to the large-capacity memory can be output as read data. This makes it possible to omit a processing in which a read request is issued after waiting for accumulation completion of the write buffer or reception of a write request to the large-capacity memory or a write response with passage of time. Accordingly, after issuing a write request to the write buffer, a read request can be issued any time to output a packet. This makes it possible to reduce the amount of delay from packet input until packet output.

For example, since read control according to packet input becomes possible, it is possible to perform output band control in which burstiness of packet output is reduced, and it is possible to enhance the transmission efficiency in an entire network. For example, since it is possible to omit forced write control via time monitoring, it is possible not to manage control information, such as packet boundary/accumulation information, for forced write control. This makes it possible to perform access control on the large-capacity memory with write control and read control that are similar to those for accessing a simple internal high-speed RAM.

For example, unlike a method for increasing an access band (“bit width”×“access frequency”) or increasing a memory capacity, for example, it is possible to avoid a power consumption increase involved in use of a large-scale device having a large number of terminals, division into a plurality of devices, and an increase in the number of memories used. For example, unlike a method for forcibly writing fractional data held in a write buffer for a certain period of time to a large-capacity memory, it is possible to avoid a state in which the large-capacity memory is accessed for only fractional data, and it is possible to suppress an increase in delay of writing.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A transmission device, comprising:
circuitry that writes, each time input data reaches a predetermined amount, the predetermined amount of the input data to a memory; and
a buffer that stores data that is included in the input data and that is not written to the memory by the circuitry,
wherein the circuitry is configured to:
read, from the memory, first data among target data for which a read request is issued, the first data being included in the input data and being written to the memory, and
read, from the buffer, second data among the target data, the second data being included in the input data and not being written to the memory.

2. The transmission device according to claim 1,
wherein the circuitry is configured to determine whether or not the target data is written to the memory, based on a result of comparison between a read address of the target data and a write address of the data written to the buffer.

3. The transmission device according to claim 2, further comprising:
another buffer that differs from the buffer and that stores the input data,
wherein the circuitry is configured to:
read, each time data stored in the other buffer reaches the predetermined amount, the predetermined amount of data stored in the other buffer, and
write the read data to the memory.

4. The transmission device according to claim 1, wherein
the input data is data received from another transmission device; and
the circuitry is configured to transmit the target data to the other transmission device.

5. The transmission device according to claim 1,
wherein the writing by the circuitry comprises writing the predetermined amount of the input data to the memory via burst transfer.

6. The transmission device according to claim 1,
wherein the buffer is a storage medium having a smaller capacity than the memory.

7. The transmission device according to claim 1,
wherein the buffer is a storage medium whose access speed is higher than an access speed of the memory.

8. A transmission method executed by circuitry in a transmission device, the transmission method comprising:
writing, each time input data reaches a predetermined amount, the predetermined amount of the input data to a memory;
storing, in a buffer, data that is included in the input data and that is not written to the memory;
reading, from the memory, first data among target data for which a read request is issued, the first data being included in the input data and being written to the memory, and
reading, from the buffer, second data among the target data, the second data being included in the input data and not being written to the memory.

9. The transmission method according to claim 8, further comprising:
determining whether the target data is written to the memory, based on a result of comparison between a read address of the target data and a write address of the data written to the buffer,
wherein the reading the first data includes
reading the first data when it is determined that the target data is written to the memory.

10. The transmission method according to claim 9, further comprising:
storing the input data in another buffer that differs from the buffer;
reading, each time data stored in the another buffer reaches the predetermined amount, the predetermined amount of data stored in the another buffer; and
writing the read data to the memory.
